(19) United States
(12) Patent Application Publication
(10) Pub. No.: US 2023/0364449 A1
(43) Pub. Date: Nov. 16, 2023

(54) A RE-USABLE PERSONAL PROTECTIVE EQUIPMENT KIT BATTERY POWERED FILTERED AIR VENTILATION AND COMMUNICATION DEVICE FOR PROTECTIVE SHIELDING

(71) Applicants: Ashok Shukla, Noida (IN); Pushpa Rani Shukla, Noida (IN)

(72) Inventors: Ashok Shukla, Noida (IN); Pushpa Rani Shukla, Noida (IN)

(21) Appl. No.: 18/028,728

(22) PCT Filed: Sep. 27, 2021
(86) PCT No.: PCT/IN2021/050944

§ 371 Date: Mar. 27, 2023

(51) Int. Cl. A62B 17/00; A62B 18/04; A62B 23/02

(52) U.S. Cl. CPC A62B 17/006; A62B 18/045; A62B 23/02

(57) ABSTRACT

Disclosed is a re-usable an integrated wearable suit (100) including battery powered ventilation for providing protective shield with complete safety from viral and bacterial loads, and a transparent head shield (102), a microphone (116) with dual speakers (118) for peer communication, a microsensor (107) for filter clogging sensing, alarm display device and amplifier connected to re-chargeable battery backup (108), a torso (120) including chain covered with a sealable flap facilitating the opening and closing of the kit, a lower body part (136) extending from mid hip to ankle and shaped for movement comfort of both legs and bending and sitting freedom, a pair of shoes covers (138) with a gripped bottom (140), with earthed anti-static and low voltage safety and a plurality of restricted one way air outlets (142).

### FIELD OF INVENTION

The present disclosure relates to wearable protective shields. More specifically, the present invention relates to an integrated wearable suit comprising features that include suit with a 360-degree movement that provides complete safety from external gas and liquid exposure by sealing, battery powered micro-organisms removing filtered air ventilation and individual customization and provision of oxygen cylinder attachment for rescue operations from environments of chemical hazards and fire etc.

### BACKGROUND OF THE INVENTION

In recent past years, globalisation has severely affected the environment, ecosystem and the natural resources. In recent past decades, there has been a drastic rise in fatal and harmful bacterial, pathogenic and microbial disease due to urbanisation. In order to avoid contamination and spread of virus, several integrated wearable suits, wearable shields and other wearables have been introduced in the market. Such shields and wearables include head shields, masks, gloves, PPE kits and the like. Furthermore, there are arrangements to the conventional PPE kits to protect a human body from harmful diseases.

However, there are quite number of limitations with the kits efficiency in restricting the viruses, comfort ability in wearing for prolonged hours, configurations such as ease of put up and put off. Moreover, there are also limitations with the efficiency of protection by conventional kits due to certain areas of the body remaining uncovered, for example portions of face, neck, ankles etc. susceptible to infections in spite of socks (having porosity) or bare skin allowing viral and bacterial transmission to the body by way of skin (even skin is highly susceptible to certain infections like measles, chicken pox, dermatitis, herpes etc.), rendering the human anatomy susceptible to increased fatality besides being highly contagious and may include viruses and bacterial infections having capability of transmission through skin in the near future.

Therefore, there is a dire need to overcome the limitations related with the conventional wearable protective shields.

### SUMMARY OF THE INVENTION

In an aspect of the invention, an integrated wearable suit is provided. The integrated wearable suit includes a headshield having a fan inlet equipped with a multilayer dampened air filter and a torso provided with a sealable flap wherein the torso is connected to the headshield and a pair of shoe covers. The fan inlet is configured to maintain a positive air pressure inside the integrated wearable suit.

In another aspect of the invention, the torso of the integrated wearable suit further comprising an outside sanitaziable plastic layer, an inside cotton mixed woven or nonwoven fabric layer and an anti-static film layer sandwiched between the outside plastic layer and the inside cotton mixed woven or nonwoven fabric layer is provided.

In yet another aspect of the invention, the torso is connected to the semi-rigid neck part and the pair of shoe covers through a sealable tape is provided.

In yet another aspect of the invention, the torso is connected to the headshield by the sealable tape is provided.

In yet another aspect of the invention, the anti-static layers of multi-layer dampened air filter assembly, head shield and torso are earthed through the shoe cover and the anti-static layer gripped bottom structure by wire and plug assemblies at each joint of respective parts so as to reach to earthing strips is provided.

In yet another aspect of the invention, the multi-layer dampened air filter is configured to filter the external air sucked inside the integrated wearable suit through a fan of the fan inlet.

In yet another aspect of the invention, the fan inlet (104) is configured to maintain the positive air pressure lies between 1 mm of Hg to 10 mm Hg.

In another aspect, the fan inlet (104) is configured to maintain the positive air pressure in the range of 3 mm of Hg to 7 mm of Hg.

In another aspect, the fan inlet (104) is configured to maintain the positive air pressure in the range of 2 mm of Hg to 8 mm of Hg is provided.

In yet another aspect of the invention, the headshield further comprises a microphone, a microsensor operatively coupled to multi-layer dampened air filter assembly for filter cogging signal and a dual speaker.

In yet another aspect of the invention, the fan inlet is operatively coupled with a rechargeable battery backup for supplying electrical power to the fan inlet, the micro-phone, the filter microsensor for filter clogging indication, alarm display device and amplifier, and to the dual speaker.

In yet another aspect of the invention, a torso of an integrated wearable suit worn by a user including a sealable flap provided with a chain. The sealable flap extends from the neck of the user in the front of the integrated wearable suit through portion between two legs between both hips right to the top of the suit at the back side right up to below the headshield of the user in the back of the integrated wearable suit.

In yet another aspect of the invention, the torso includes a provision of oxygen cylinder attachment of up to 1 kg.

In yet another aspect of the invention, the torso includes a provision of oxygen cylinder attachment of up to 2 kg.

In yet another aspect of the invention, the torso includes a provision of oxygen cylinder attachment of up to 3 kg.

### BRIEF DESCRIPTION OF THE DRAWINGS

Other objects, features, and advantages of the embodiment will be apparent from the following description when read with reference to the accompanying drawings. In the drawings, wherein like reference numerals denote corresponding parts throughout the several views:

FIG. 1 is an illustration of a re-usable integrated wearable suit including battery powered ventilation for providing protective shield from external exposure.

### DETAILED DESCRIPTION OF THE PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

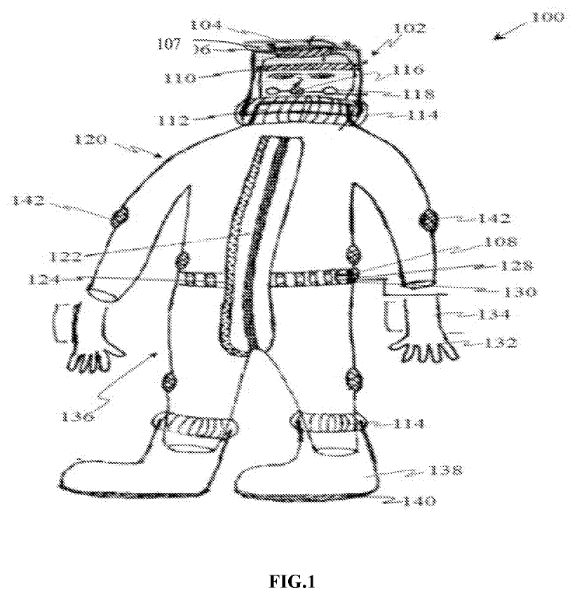

Referring to FIG. 1 illustrated is an illustration of a re-usable integrated wearable suit (100). The integrated wearable suit (100) provides a battery powered ventilation for enabling protective shield from external exposure, in accordance with an embodiment of the present disclosure.

The re-usable integrated wearable suit (100) includes a transparent head shield (102) (hereinafter referred to as headshield), a sealable tape (114), a torso (120), a pair of gloves (132), a lower body part (136), a pair of shoe covers (138), and a plurality of air check valves (142).

The headshield (102) further includes a fan inlet (104), a semi rigid headband foam (110), a semi-rigid neck collar (112), a microphone (116) and a dual speaker (118).

The fan inlet (104) of the headshield (102) further includes a fan (not shown) and a multi-layered dampened air filter (106). The fan inlet (104) is operatively coupled with a rechargeable battery backup (108). The multi-layer dampened air filter (106) along with a microsensor (107) for filter clogging sensing and sending signal to alarm device is positioned inside the headshield (102). The microsensor is further positioned in between the fan and multi-layered dampened air filter (106). The multi-layered dampened air filter (106) enables purification of external air being sucked inside the integrated wearable suit (100) along with a wire and plug to be assembled to torso (120) for anti-static earthing connection further to shove cover and earthing strip.

The torso (120) further includes a sealable flap (122), a belted waist battery pack (124), a buckle (128) and an external rechargeable plug socket (130) along with a wire and plug to be assembled to shoe cover part for anti-static earthing connection further to earthing strip.

The pair of gloves (132) further includes an extended overlap part (134) to be coupled with the torso (120) at the wrist.

The pair of shoe covers (138) (hereinafter referred to as a shoe cover) further includes a gripped bottom surface (140) along with a wire for anti-static earthing through earthing strip.

The torso (120) also includes provision of oxygen cylinder attachment of up to 1 kg. The torso (120) also includes provision of oxygen cylinder attachment of up to 2 kg. The torso (120) also includes provision of oxygen cylinder attachment of up to 3 kg. The provision of oxygen cylinder attachment depends on the area of usage, for facilitating breathing while in rescue operations in environments of hazardous gases and fire etc where filtration of ambient air is not sufficient for breathing.

The fan inlet (104) of the headshield (102) is configured to maintain a positive air pressure for ensuring continuous fresh air supply for easy breathability. The multi-layer dampened air filter (106) of the fan inlet (104) ensures consistent filtered air supply through the fan inlet (104) that eliminates any possibility of ingress of any gas or liquid inside therein. The positive air pressure so maintained inside the integrated wearable suit (100) ensures ejection of air outside, from inside of the integrated wearable suit (100), in case of any accidental opening or tearing of the integrated wearable suit (100) or the integrated wearable suit (100) being pierced by a sharp object that might be infected and ensuring that the outside infected or hazardous air or gases are not inlet inside the wearable suit (100) in any way. Thus, the positive air pressure maintained inside the integrated wearable suit (100) ensures decontamination or prevent infection dissemination by abstaining the infected air to enter inside the integrated wearable suit (100) through the hole/breaking caused by accident.

In another embodiment, the fan inlet (104) of the headshield (102) is configured to maintain a positive air pressure of at least 1 mm Hg to 10 mm Hg and so forth for ensuring continuous fresh air supply for easy breathability.

In another embodiment, the fan inlet (104) of the headshield (102) is configured to maintain a positive air pressure in the range of 3 mm of Hg to 7 mm of Hg.

In another embodiment, the fan inlet (104) of the headshield (102) is configured to maintain a positive air pressure in the range of 2 mm of Hg to 8 mm of Hg.

The semi rigid head band foam (110) provides a support for stability of the transparent head shield (102), semi rigid neck collar (112) assembled with a sealable tape working as a covering (114), furthermore, this assembly is adjustable according to individual height, a microphone (116) with dual speakers (118) for peer communication, an electronic amplifier for speakers and microphone and alarm indication device with both display and voice alarm for filter change indication with feature of alarm pause and connected to the re-chargeable battery backup (108) from inside with low voltage type ensuring safety of the person wearing the set and is not capable of generating any electrical shock or spark at any time.

The sealable flap (122) extending from the front side of the integrated wearable suit (100) to the back side of the integrated wearable suit (100) starting from below the neck in front to going through between two hips and ending at the top of the torso (120) right up to the back side of the neck of the wearer just below the head shield (102) thus facilitating easy doffing and donning of the integrated wearable suit (100). The sealable flap (122) also ensures partial wearing and taking off the integrated wearable suit (100) while using washroom facilities and the like, the sealable flap (122) in assembled form and customised according to the wearer and is fixed into the torso (120).

The torso (120) is manufactured of three-layered structure including outside of easy cleanable and sanitizable plastic layer outside and the inside made of cotton mixed woven or nonwoven fabric to give a comfortable feel to the wearer sandwiched with anti-static film layer, and such an anti-static film layer connected with similar anti-static layers of head shield (102) and shoe cover (138) through wire and plug so as to earth the static electricity through earthing strip.

The belted waist battery pack (124) of the torso (120) is configured to power the fan inlet (104) that is provided with the multi-layered dampened air filter (106), the microphone (116) and the dual speakers (118), the micro sensor (107) for filter clogging, the alarm display device and amplifier. The buckle (128) is configured to tight or loose the integrated wearable suit (100) for better fitment. The external rechargeable plug socket (130) enables charging of the battery pack (122).

The lower body part (136) of the integrated wearable suit (100) extends from the mid hip to the ankle of the wearer with shape ensuring movement comfort of the wearer as well. The lower body part (136) is manufactured of three-layered structure including outside of efficiently and effortlessly sanitizable cleanable plastic layer and inside made of cotton mixed woven or nonwoven fabric to give a comfortable feel to the wearer sandwiched with anti-static film layer.

The pair of shoe covers (138) are manufactured of three layered structure including outside of easy sanitizable cleanable plastic layer and the inside made of cotton mixed woven or nonwoven fabric to give a comfortable feel to the wearer sandwiched with anti-static film layer with plug and socket connectivity between the head assembly, coverall wiring and shoe covers wiring so as to connect the earthing wires of the coverall with earthing strips in the shoe covers assembled with a sealable tape (114) working as a covering. Furthermore, the gripped bottom structure (140) of the shoe cover (138) along with earthing strip assembled in the shoe cover (138) with anti-slip hard bottom to avoid slippage on the floor as well as any static charge generation inside or outside the kit in the three-layered structures through lamination of anti-static film in the fabric structure.

The number of check valves (142) enables to maintain positive air pressure inside the integrated wearable suit (100). The integrated wearable suit (100) also has the provision of earthing of internal circuitry of low voltage type ensuring safety of the person wearing the set and is not capable of generating any electrical shock or spark at any time and entire coverall to be in conductive contact with floor and connects with the earthing strip assembled in shoe cover anti slip hard bottom to avoid any static charge generation inside or outside the kit in the 3 layered structure through lamination of anti-static film in the fabric structure. Notably, the entire circuitry is low voltage type ensuring safety of the person wearing the set and is not capable of generating any electrical shock or spark at any time.

We claim:

1. An integrated wearable suit (100), the wearable suit comprising;
a) a headshield (102),
b) a fan inlet (104) equipped with a multilayer dampened air filter (106) across the wearable suit (100); and
c) a torso (120) provided with a sealable flap (122);
wherein the torso (120) is connected to the headshield (102) and a pair of shoe covers (118);
wherein the fan inlet (104) is configured to maintain a positive air pressure inside the integrated wearable suit (100).

2. The integrated wearable suit (100) of claim 1, wherein the torso (120) further comprising an outside sanitaziable plastic layer, an inside cotton mixed woven or nonwoven fabric layer and an anti-static film layer sandwiched between the outside plastic layer and the inside cotton mixed woven or nonwoven fabric layer.

3. The integrated wearable suit (100) of claim 1, wherein the torso (120) is connected to the semi-rigid neck part (112) and the pair of shoe covers (118) through a sealable tape (114).

4. The integrated wearable suit (100) of claim 1, wherein the torso is connected to the headshield (102) by the sealable tape (114).

5. The integrated wearable suit (100) of claim 2, wherein the anti-static layers of multi-layer dampened air filter (106) assembly, head shield (102) and torso (120) are earthed through the shoe cover (138) and the anti-static layer gripped bottom structure (140) by wire and plug assemblies at each joint of respective parts so as to reach to earthing strips.

6. The integrated wearable suit (100) of claim 1, wherein the multi-layer dampened air filter (106) is configured to filter the external air sucked inside the integrated wearable suit (100) through a fan of the fan inlet (104).

7. The integrated wearable suit (100) of claim 1, wherein the fan inlet (104) is configured to maintain the positive air pressure in the range of 1 mm of Hg to 10 mm of Hg.

8. The integrated wearable suit (100) of claim 7, wherein the fan inlet (104) is configured to maintain the positive air pressure in the range of 3 mm of Hg to 7 mm of Hg.

9. The integrated wearable suit (100) of claim 7, wherein the fan inlet (104) is configured to maintain the positive air pressure in the range of 2 mm of Hg to 8 mm of Hg.

10. The integrated wearable suit (100) of claim 1, wherein the headshield (102) further comprises a microphone (116), a microsensor (107) operatively coupled to multi-layer dampened air filter (106) assembly for filter cogging signal and a dual speaker (118).

11. The integrated wearable suit (100) of claim 1, wherein the fan inlet (104) is operatively coupled with a rechargeable battery backup (108) for supplying electrical power to the fan inlet (104), the micro-phone (116), the filter microsensor (107) for filter clogging indication, alarm display device and amplifier, and to the dual speaker (118).

12. A torso (120) of an integrated wearable suit (100) worn by a user, the torso comprising;
a sealable flap (122) provided with a chain;
wherein the sealable flap (122) extends from below the neck of the user in the front of the integrated wearable suit (100) through portion between two legs between both hips right to the top of the suit at the back side right up to below the headshield 102(of the user in the back of the integrated wearable suit (100).

13. The torso (120) of claim 12, wherein the torso includes a provision of oxygen cylinder attachment of up to 1 kg.

14. The torso (120) of claim 12, wherein the torso includes a provision of oxygen cylinder attachment of up to 2 kg.

15. The torso (120) of claim 12, wherein the torso includes a provision of oxygen cylinder attachment of up to 3 kg.
